(19) United States
(12) Patent Application Publication
(10) Pub. No.: US 2026/0350884 A1
(43) Pub. Date: Nov. 5, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: MASATOSHI ISHII, Tokyo (JP)

(21) Appl. No.: 19/659,194

(22) Filed: Apr. 27, 2026

(30) Foreign Application Priority Data
May 2, 2025 (JP) 2025-076760

(51) Int. Cl. G06T 11/60; G06T 5/50; G06T 7/55; G06F 3/14

(52) U.S. Cl. CPC G06T 11/60; G06T 5/50; G06T 7/55; G06F 3/14; G06T 2207/10024; G06T 2207/20192; G06T 2207/20212

(57) ABSTRACT

An image processing apparatus including a real image acquisition unit configured to acquire a real image, a virtual image acquisition unit configured to acquire a virtual image, and a composition processing unit configured to composite the real image and the virtual image through composition processing, wherein, in a case where a predetermined display setting is set, the composition processing unit executes processing for displaying a virtual object regardless of a front-to-back positional relationship in occlusion between a real object in the real image and the virtual object in the virtual image.

### BACKGROUND

### Field of the Technology

The present disclosure relates to an image processing apparatus, an image processing method, and a storage medium.

### Description of the Related Art

For example, a head mounted display (HMD) is provided as a device used to experience mixed reality (MR) content. By generating and displaying images (such as moving images and still images) based on a user's position and posture using the HMD, a user can experience a feeling as if the user is moving in a space where reality and computer graphics (CG) are mixed.

A video see-through HMD is provided as a device for providing MR experience in which reality and CG are mixed. A video see-through HMD generates a display image by compositing a CG image with a real image acquired from a camera mounted on the HMD, and provides the MR experience by making the user view the display image through the HMD. At this time, the HMD can achieve highly-realistic visual expression by correctly expressing an occlusion relationship between a real object and a virtual object, i.e., a CG object. Japanese Patent Laid-Open No. 2022-183177 discusses a technique for expressing and displaying augmented reality (AR) with correct occlusion by calculating a CG area occluded by a real object by using information about occlusion between real images and CG images for the right and left eyes.

### SUMMARY

The present disclosure is directed to an image processing apparatus capable of allowing a user to easily understand what kinds of virtual objects (CG objects) are arranged in a space even in a case where the virtual object is occluded by a real object.

According to an aspect of the present disclosure, an image processing apparatus includes a real image acquisition unit configured to acquire a real image, a virtual image acquisition unit configured to acquire a virtual image, and a composition processing unit configured to composite the real image and the virtual image through composition processing, wherein, in a case where a predetermined display setting is set, the composition processing unit executes processing for displaying a virtual object regardless of a front-to-back positional relationship in occlusion between a real object in the real image and the virtual object in the virtual image.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a perspective view of a configuration example of an image display system according to one or more aspects of the present disclosure.

FIG. 2 is a diagram schematically illustrating an example of an internal configuration of a head mounted display (HMD).

FIG. 3 is a block diagram illustrating an example of a hardware configuration of the image display system according to one or more aspects of the present disclosure.

FIG. 4 is a block diagram illustrating an example of a configuration included in a central processing unit (CPU) of an image processing apparatus.

FIG. 5 is a flowchart illustrating processing for setting a display mode.

FIG. 6 is a flowchart illustrating processing for displaying a composite image on the HMD.

FIG. 7 is a flowchart illustrating details of display image generation processing according to one or more aspects of the present disclosure.

FIG. 8 is a flowchart illustrating details of normal display mode processing.

FIG. 9 is a diagram schematically illustrating a positional relationship between a real object and computer graphics (CG) objects in an expected mixed reality (MR) scene according to one or more aspects of the present disclosure.

FIGS. 10A-10C are diagrams schematically illustrating examples of a real image and rendered images.

FIGS. 11A and 11B are diagrams schematically illustrating examples of display images including a real object and a CG object.

FIG. 12 is a block diagram illustrating an example of a configuration included in a CPU of an image processing apparatus according to one or more aspects of the present disclosure.

FIG. 13 is a flowchart illustrating details of display image generation processing according to one or more aspects of the present disclosure.

FIGS. 14A and 14B are diagrams schematically illustrating examples of enhanced images generated by executing image enhancement processing on the rendered images in FIGS. 10B and 10C.

FIG. 15 is a diagram schematically illustrating an example of a display image generated by CG-priority display mode processing according to one or more aspects of the present disclosure.

FIG. 16 is a block diagram illustrating an example of a configuration included in a CPU of an image processing apparatus according to one or more aspects of the present disclosure.

FIG. 17 is a flowchart illustrating details of display image generation processing according to one or more aspects of the present disclosure.

FIG. 18 is an overhead view illustrating a relationship between real objects, CG objects, and a display distance setting value according to one or more aspects of the present disclosure.

FIG. 19 is a diagram schematically illustrating a positional relationship between a real object and CG objects in an expected MR scene according to one or more aspects of the present disclosure.

FIGS. 20A-20C are diagrams schematically illustrating examples of a real image and rendered images.

FIGS. 21A and 21B are diagrams schematically illustrating examples of display images including a real object and a CG object.

FIG. 22 is a flowchart illustrating details of display image generation processing according to one or more aspects of the present disclosure.

### DESCRIPTION OF THE EMBODIMENTS

When a computer graphics (CG) object is seen from a viewing position of a head mounted display (HMD) user, the CG object may or may not be occluded by a real object. In such a case, it is difficult for the HMD user to easily understand what kinds of CG objects are arranged in a space.

Hereinafter, embodiments of the present disclosure are described in detail with reference to drawings. The embodiments are described with respect to cases where the present disclosure is applied to an image processing system including an HMD.

In addition, the following embodiments are not intended to limit the present disclosure according to a scope of appended claims. Although various features are described in the embodiments, not all of the features are essentially required for the present disclosure, and the plurality of features may be combined optionally. Further, in the drawings, same reference numerals are applied to components identical or similar to each other, and duplicative descriptions are omitted. Details of dimensions and structures described in the embodiments are not limited to those described in the specification and drawings.

### First Embodiment

First, a first embodiment will be described.

### Configuration of Image Processing System

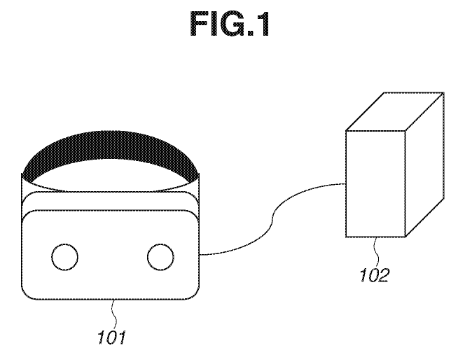

FIG. 1 is a diagram illustrating a perspective view of a configuration example of an image display system according to the present embodiment.

The image display system includes a head mounted display (HMD) 101 and an image processing apparatus 102. The HMD 101 and the image processing apparatus 102 are connected to each other via a predetermined communication path, so that the HMD 101 and the image processing apparatus 102 can mutually transmit and receive various types of data such as image data and various control signals. In the example illustrated in FIG. 1, the HMD 101 and the image processing apparatus 102 are connected to each other via a cable compliant with standards such as High-Definition Multimedia Interface (HDMI) (Registered Trademark) and universal serial bus (USB). Naturally, a type of communication path for connecting the HMD 101 and the image processing apparatus 102 is not limited in particular. As a specific example, a communication path between the HMD 101 and the image processing apparatus 102 may be established by wireless communication such as Bluetooth (Registered Trademark).

Further, the configuration illustrated in FIG. 1 is merely an example, and is not intended to limit the system configuration of the image display system according to the present embodiment. Specifically, for example, input devices such as a controller and a keyboard (not illustrated) for receiving inputs from the user may be connected to the image processing apparatus 102 via a predetermined communication path.

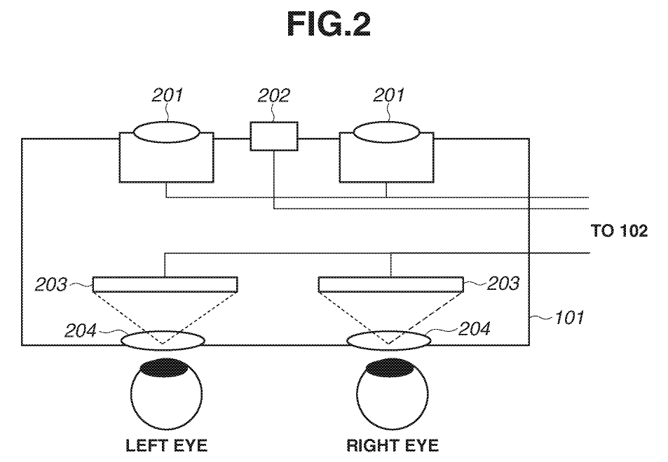

FIG. 2 is a diagram schematically illustrating an example of an internal configuration of the HMD 101.

The HMD 101 includes a plurality of image capturing apparatuses 201 (for example, RGB cameras) for visualizing a real space. Further, in order to implement its own position tracking, the HMD 101 includes an internal measurement unit (IMU) such as a gyroscope or an acceleration sensor and an image capturing apparatus, all of which are not illustrated.

The HMD 101 includes a configuration for acquiring depth information that indicates a distance to an object in an external environment. For example, in the example illustrated in FIG. 2, the HMD 101 includes a distance sensor 202 such as a light detection and ranging (LiDAR) sensor as a configuration for acquiring the depth information.

As the configuration for displaying an image, the HMD 101 further includes displays 203 for the right and the left eyes that employ display panels such as liquid crystal panels or organic electro-luminescence (EL) displays. Further, eyepiece lenses 204 are arranged between the displays 203 and the user's right and left eyes. Through the above-described configuration, the user who wears the HMD 101 can observe enlarged virtual images of display images displayed on the displays 203 via the eyepiece lenses 204.

The HMD 101 is mounted on the user's head (not illustrated), and allows the user to observe a display image (of an enlarged virtual image) for the left eye and a display image (of an enlarged virtual image) for the right eye through the user's left and right eyes. The image processing apparatus 102 generates these display images for the right and the left eyes, and displays these images on the displays 203 of the HMD 101. At this time, the image processing apparatus 102 may add parallax between the display images for the right and the left eyes, depending on the distance between the right and the left eyes of the user who wears the HMD 101 (e.g., the distance between the eyepiece lenses 204 for the right and the left eyes). By executing the above-described control, visual perception with a sense of depth can be provided to the user wearing the HMD 101.

Although the present embodiment is described focusing on a system configuration where the image processing apparatus 102 is implemented as an apparatus independent from the HMD 101, the present embodiment is not intended to limit the configuration of the image display system according to the present embodiment. Specifically, for example, the image display system according to the present embodiment may be implemented by an integrated HMD system in which a configuration corresponding to the image processing apparatus 102 is included in the HMD 101.

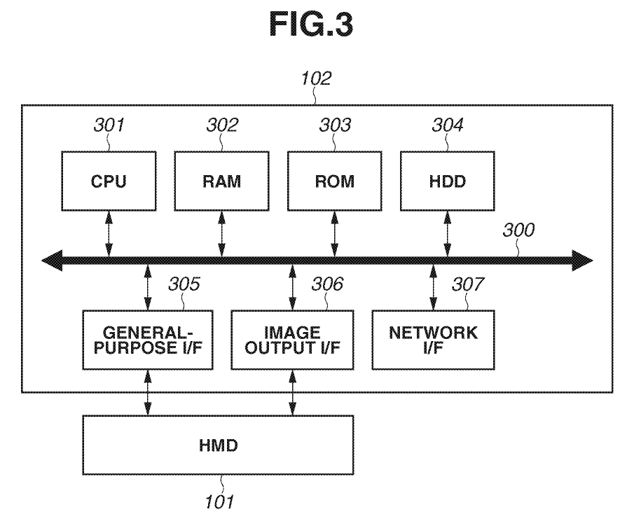

FIG. 3 is a block diagram illustrating an example of the hardware configuration of the image display system according to the present embodiment. Hereinafter, the image processing apparatus 102 will be described particularly focusing on its configuration.

The image processing apparatus 102 includes a central processing unit (CPU) 301, a random access memory (RAM) 302, and a read only memory (ROM) 303. The image processing apparatus 102 further includes a hard disk drive (HDD) 304, a general-purpose interface (I/F) 305, an image output I/F 306, and a network I/F 307. The above-described components included in the image processing apparatus 102 are connected to each other, and can transmit and receive information via a main bus 300.

The CPU 301 is a processor which generally controls the respective elements included in the image processing apparatus 102.

The RAM 302 functions as a main memory and a work area of the CPU 301. The ROM 303 stores a group of programs executed by the CPU 301. The HDD 304 is a storage area for storing applications executed by the CPU 301 and data used for image processing. In addition, the storage area is not limited to the HDD, and various types of storage devices can be employed. Specifically, for example, an auxiliary storage device such as a solid state drive (SSD) can be employed instead of or in addition to the HDD 304.

The general-purpose I/F 305 is a serial bus interface compliant with standards such as USB and Institute of the Electrical and Electronics Engineers (IEEE) 1394. For example, the general-purpose I/F 305 is connected to the IMU and the distance sensor provided in the HMD 101. With this configuration, the image processing apparatus 102 can acquire posture information and a depth image indicating a depth to a target object (i.e., an image in which depth information according to a measurement result of a distance to a target object is mapped for each pixel). The general-purpose I/F 305 is also used to acquire an image based on the results of image capturing executed by the image capturing apparatuses 201 included in the HMD 101. Further, a keyboard and a mouse for receiving user's inputs may also be connected to the general-purpose I/F 305.

The image output I/F 306 is an interface such as the HDMI or a display port. The image output I/F 306 is used to transmit display images to be displayed on the displays 203 of the HMD 101 to the HMD 101. The network I/F 307 is an interface for connecting the image processing apparatus 102 to a predetermined network. In addition, a configuration of the network I/F 307 may be changed as appropriate depending on a type of a network the image processing apparatus 102 is connected to and a communication method to be employed. Further, a wireless communication interface such as Bluetooth is also included in the network I/F 307. For example, a device such as a controller which allows the user to perform operation and setting change of an application is connected to the image processing apparatus 102 via Bluetooth.

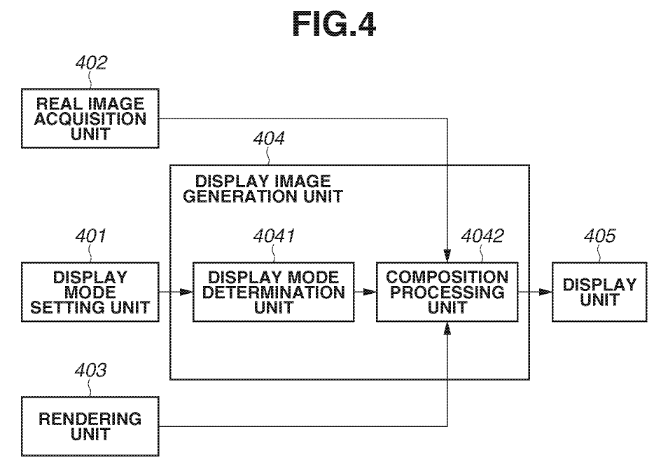

FIG. 4 is a block diagram illustrating an example of a configuration included in the CPU 301 of the image processing apparatus 102.

The image processing apparatus 102 includes a display mode setting unit 401, a real image acquisition unit 402, a rendering unit 403, a display image generation unit 404, and a display unit 405. These components are implemented as respective functions of the CPU 301. The display image generation unit 404 includes a display mode determination unit 4041 and a composition processing unit 4042.

Based on the operation performed by the user, the display mode setting unit 401 sets either of a normal display mode or a CG-priority display mode, which is a predetermined display setting, as a display mode. In the normal display mode, objects are displayed with consideration for occlusion between a real image and a CG image as a virtual image. In the CG-priority display mode, a CG object is always displayed in a foreground without consideration for occlusion, regardless of the front-to-back positional relationship in occlusion between a real object in a real image and a CG object as a virtual object in a CG image.

The real image acquisition unit 402 acquires a real image captured by each of the image capturing apparatuses 201. The real image consists of two images, one for the right and one for the left eye.

The rendering unit 403 functions as a virtual image acquisition unit that acquires a CG image, and generates a rendered image by executing rendering processing on the CG image. At this time, the rendering unit 403 generates two rendered images for the images for the right and the left eyes by setting virtual cameras for the right and the left eyes. Further, an image-capturing parameter such as an angle of view and a rendering resolution of the virtual camera are appropriately set based on an image-capturing parameter and an image-capturing resolution of each of the image capturing apparatuses 201.

The display image generation unit 404 generates a display image by executing composition processing using the real image and the rendered image. The display unit 405 transmits the display image to the HMD 101 via the image output I/F 306 and displays the display image on the displays 203.

The display mode determination unit 4041 determines whether the display mode set by the display mode setting unit 401 is the normal display mode or the CG-priority display mode.

The composition processing unit 4042 generates a composite image based on the display mode by using the real image and the rendered image. In a case where a display mode is the normal display mode, a composite image is generated with consideration for occlusion between the real object and the CG object. On the other hand, in a case where the display mode is the CG-priority display mode, a composite image in which a CG object is always displayed in the foreground without consideration for occlusion is generated regardless of the front-to-back positional relationship in occlusion between the real object and the CG object.

### Image Processing Method

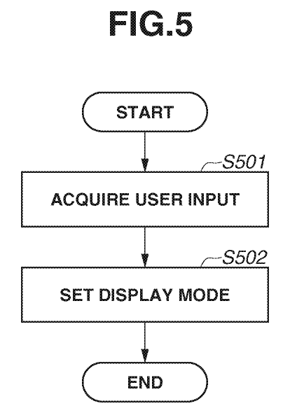

FIG. 5 is a flowchart illustrating processing for setting a display mode.

A series of processing illustrated in FIG. 5 is implemented by the CPU 301 by loading a program stored in the ROM 303 or the HDD 304 into the RAM 302 and executing the program. Through the processing, the CPU 301 serves as the respective components illustrated in FIG. 4. In addition, the above-described processing may be executed asynchronously with the processing for generating and displaying a composite image described below.

In step S501, the display mode setting unit 401 acquires a user's input related to a display mode setting, from a controller connected to the image processing apparatus 102 via the network I/F 307 or a keyboard or a mouse connected thereto via the general-purpose I/F 305. For example, the display mode setting unit 401 acquires information indicating pressing of a specific button arranged on the controller.

In step S502, the display mode setting unit 401 sets a display mode based on the input from the user acquired in step S501. In a case where the user's input is an input corresponding to a normal display mode, the display mode setting unit 401 changes a display mode to the normal display mode, and stores the display mode in the RAM 302. In a case where the user's input is an input corresponding to a CG-priority display mode, the display mode setting unit 401 changes a display mode to the CG-priority display mode, and stores the display mode in the RAM 302.

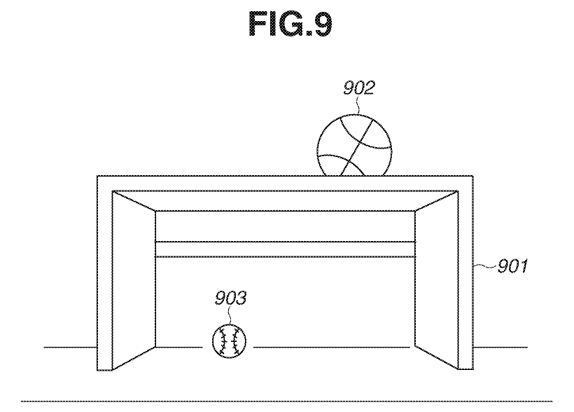

FIG. 9 is a diagram schematically illustrating a positional relationship between a real object and CG objects in an expected MR scene according to the present embodiment.

A composite image illustrated in FIG. 9 includes a real object 901 representing an actual desk, a CG object 902 representing a basketball placed on top of the real object 901 representing the actual desk, and a CG object 903 representing a baseball placed under the real object 901 representing the actual desk. Hereinafter, display image generation processing based on the display mode according to the present embodiment will be described in detail with reference to this expected scene.

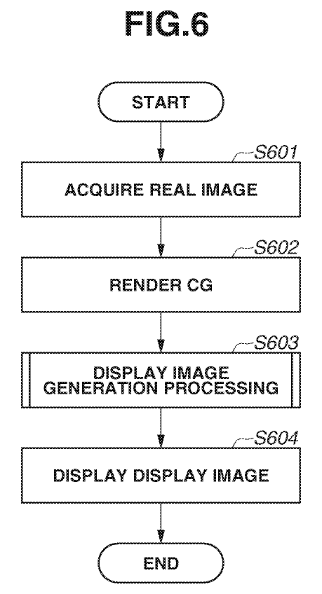

FIG. 6 is a flowchart illustrating processing for displaying a composite image on the HMD.

The flowchart in FIG. 6 illustrates a flow of processing for one frame. Accordingly, by repeatedly executing this processing 60 times per second, for example, the HMD 101 can display a video as a moving image at a frame rate of 60 fps to the user.

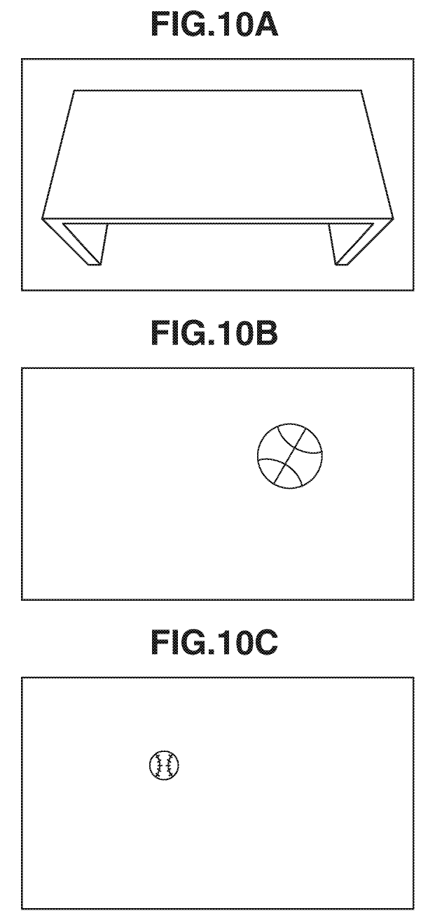

In step S601, the real image acquisition unit 402 acquires a real image captured by the image capturing apparatuses 201 and stores the real image in the RAM 302. FIG. 10A illustrates an example of the real image. In this example, a real image in which a real object (i.e., a desk) is captured in a situation where the HMD user looks down at a desk from above is acquired. Although only an image for one eye is illustrated in FIG. 10B and 10C, a real image consists of two images, one for the right and one for the left eye. Further, in step S601, a depth image corresponding to the real image is acquired simultaneously. A depth image may be acquired from a real image using known stereo depth estimation processing, or a depth image generated by using the information acquired by the distance sensor 202 may be acquired. Further, a depth image generated by a combination of these methods may be acquired.

In step S602, the rendering unit 403 generates a rendered image by executing rendering processing on the CG object, and stores the rendered image in the RAM 302. FIGS. 10B and 10C illustrate examples of the rendered images. These examples illustrate rendered images generated from two different applications. In FIG. 10B, a rendered image in which a CG object of a basketball is rendered is generated from one of the applications. In FIG. 10C, a rendered image in which a CG object of a baseball is rendered is generated from the other application. In the present embodiment, with respect to pixels corresponding to the CG objects of a basketball and a baseball, 1 (non-transparent) is set as a value of an alpha channel for each of the rendered images generated from the respective applications. Further, 0 (transparent) is set for other pixels.

Although only an image for one eye is illustrated in each of FIGS. 10B and 10C, a rendered image consists of two images, one for the right and one for the left eye. At this time, the rendering unit 403 generates two rendered images, one for the right and one for the left eye by setting virtual cameras for the right and the left eyes. Further, an image-capturing parameter such as an angle of view and a rendering resolution of the virtual camera are set so as to ensure consistency based on an image-capturing parameter and an image-capturing resolution of each of the image capturing apparatuses 201.

Further, the rendered image includes information about an alpha channel indicating transparency of a CG image, in addition to RGB channels. As for an area where the CG object is not present in the rendered image, 0 (transparent) is set as the alpha channel value.

Further, in step S602, a depth image corresponding to the rendered image and which indicates depth information is generated simultaneously.

In step S603, the display image generation unit 404 generates a composite image by using the real image and the rendered image. Details of the processing will be described below.

In step S604, the display unit 405 transmits the composite image to the HMD 101 via the image output I/F 306, and displays the composite image on the displays 203. The user can experience MR by viewing the composite image.

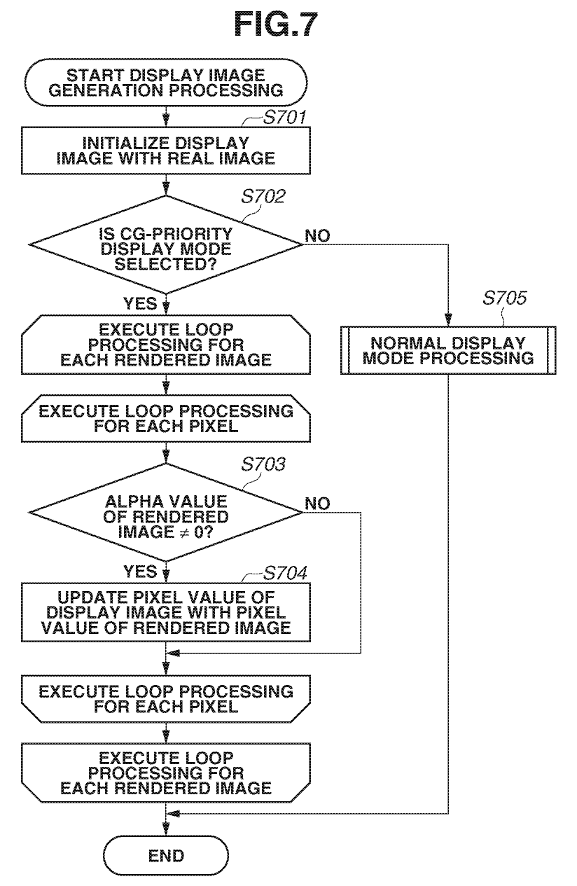

FIG. 7 is a flowchart illustrating details of display image generation processing according to the present embodiment.

In step S701, the composition processing unit 4042 reads information about a real image from the RAM 302, and initializes pixel values of a display image with pixel values of the real image. At this point, the display image is equivalent to the real image.

In step S702, the display mode determination unit 4041 acquires information about the display mode set in step S502 from the RAM 302, and determines whether the display mode is the CG-priority display mode. In a case where the display mode is the CG-priority display mode (YES in step S702), the processing proceeds to step S703. On the other hand, in a case where the display mode is not the CG-priority display mode, i.e., the display mode is the normal display mode, (NO in step S702), the processing proceeds to step S705.

In the subsequent steps, loop processing is performed for each rendered image. In the present embodiment, as described in step S602, for example, rendered images are generated from two different applications, respectively. Herein, because a plurality of rendered images, two, in this case, are present, processing is sequentially executed for the two rendered images. Further, the loop processing for each rendered image includes loop processing for each pixel, and, for each rendered image, the processing from S703 to S704 is repeatedly performed for each pixel.

In step S703, the composition processing unit 4042 reads a rendered image, which is a processing target of the loop processing currently being executed, from the RAM 302, and determines whether the alpha channel value of the rendered image is 0. In a case where the alpha channel value is not 0, i.e., a CG object is present in the area, (YES in step S703), the processing proceeds to step S704. On the other hand, in a case where the alpha channel value is 0, i.e., a CG object is not present in the area, (NO in step S703), a loop index of the pixel is updated, and the processing returns to step S703.

In step S704, the composition processing unit 4042 updates a pixel value of the display image with a pixel value of the rendered image which is a processing target of the loop processing currently being executed. That is, a CG object is displayed on this pixel.

When the processing in steps S703 and S704 is completed for all of the pixels in one rendered image, the index of the rendered image is updated, and the processing in steps S703 and S704 is executed repeatedly.

In step S705, the composition processing unit 4042 executes normal display mode processing. Details of the processing will be described below.

Through the above-described processing, when a rendered image is composited with a real image, a display image in which a CG object is always displayed in the foreground is generated regardless of the front-to-back positional relationship (depth relationship) between a real object and the CG object.

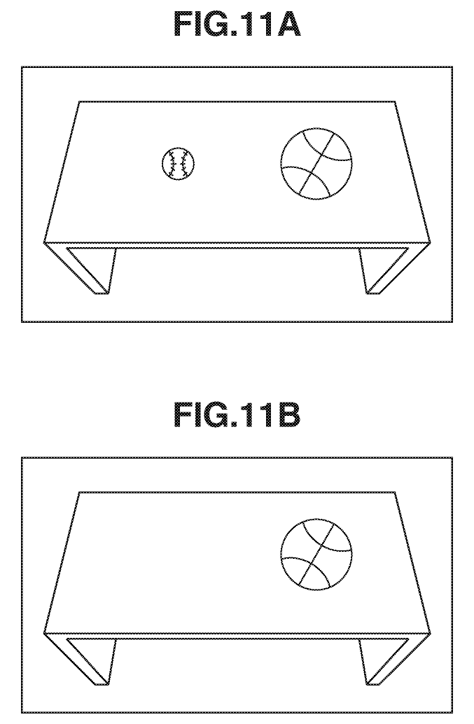

FIG. 11A is a diagram schematically illustrating an example of a display image generated by CG-priority display mode processing.

As illustrated in FIG. 11A, a display image in which two CG objects (i.e., a basketball and a baseball) are always displayed in the foreground of the real object (i.e., a desk) is generated without consideration for occlusion. The CG object representing a baseball is placed under the real object representing a desk. Therefore, originally, a proper way of expressing the baseball is to make the baseball be occluded by the desk and not visible from the user's viewing point. However, in the CG-priority display mode, a display image in which a CG object is always displayed in the foreground is generated without consideration for the front-to-back relationship. In this way, the user can easily search for and find a CG object occluded by a real object.

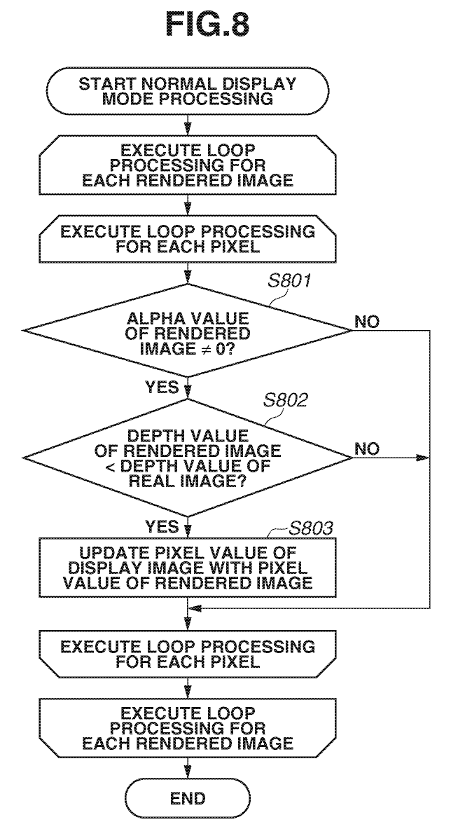

FIG. 8 is a flowchart illustrating details of normal display mode processing.

In the subsequent steps, loop processing is performed for each rendered image. In the present embodiment, as described in step S602, rendered images are generated from two different applications, respectively. Herein, because a plurality of rendered images, two, in this case, are present, processing is sequentially executed for the two rendered images. Further, the loop processing for each rendered image includes loop processing for each pixel. For each rendered image, the processing from S801 to S803 is repeatedly performed for each pixel.

In step S801, the composition processing unit 4042 reads a rendered image, which is a processing target of the loop processing currently being executed, from the RAM 302, and determines whether the alpha channel value of the rendered image is 0. In a case where the alpha channel value is not 0, i.e., a CG object is present in the area, (YES in step S801), the processing proceeds to step S802. On the other hand, in a case where the alpha channel value is 0, i.e., a CG object is not present in the area, (NO in step S801), the loop index of the pixel is updated, and the processing returns to step S801.

In step S802, the composition processing unit 4042 reads a depth image corresponding to the rendered image and a depth image corresponding to the real image from the RAM 302. Then, the composition processing unit 4042 compares a depth value of the depth image corresponding to the rendered image and a depth value of the depth image corresponding to the real image, and determines a magnitude relationship between the depth values. In a case where the depth value of the depth image corresponding to the rendered image is less than the depth value of the depth image corresponding to the real image, i.e., the CG object is in front of the real object, (YES in step S802), the processing proceeds to step S803. In a case where the depth value of the depth image corresponding to the rendered image is greater than or equal to the depth value of the depth image corresponding to the real image, i.e., the CG object is behind the real object, (NO in step S802), the loop index of the pixel is updated, and the processing returns to step S801.

In step S803, the composition processing unit 4042 updates a pixel value of the display image with the pixel value of the rendered image which is a processing target of the loop processing currently being executed. Therefore, a CG object is displayed on this pixel. At this time, in a case where the alpha channel value of the rendered image is not 1 (i.e., the object is translucent), the rendered image may be composited with the real image through an alpha-blending technique using the alpha channel value. In this way, a representation in which a translucent CG object is composited over a real image can be achieved.

By the above processing, a display image in which a real image and a rendered image are composited is generated. The display image represents occlusion in accordance with a front-to-back positional relationship (depth relationship) between a real object and a CG object.

FIG. 11B is a diagram schematically illustrating an example of a display image generated by normal display mode processing.

Occlusion between the real object (i.e., a desk) and the two CG objects (i.e., a basketball and a baseball) is represented correctly. The CG object (i.e., a basketball) placed on the real object (i.e., a desk) is visible, whereas the CG object (i.e., a baseball) placed under the real object (i.e., a desk) is occluded by the desk and not visible.

As described above, according to the present embodiment, it is possible to provide the image processing apparatus 102 capable of allowing the user to easily understand what kinds of CG objects are arranged in a space, even in a case where a CG object is occluded by a real object.

### Second Embodiment

A second embodiment will be described below. Similar to the first embodiment, the present embodiment is described with respect to a case where the present disclosure is applied to an image processing system including an HMD. The present embodiment is different from the first embodiment in that a CG object occluded by a real object is displayed in an enhanced manner.

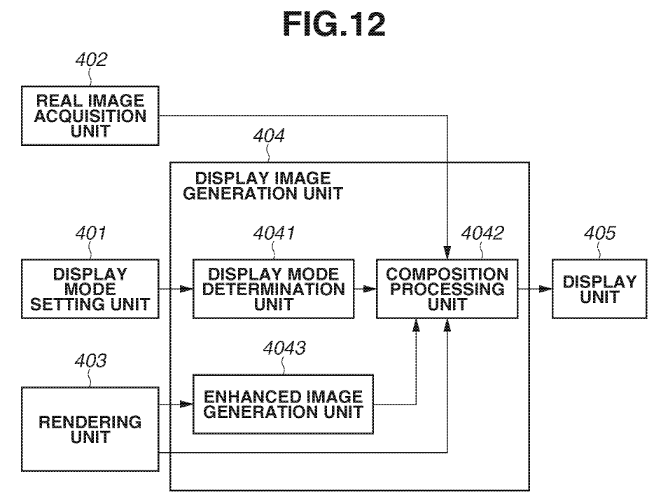

FIG. 12 is a block diagram illustrating an example of a configuration included in the CPU 301 of the image processing apparatus 102 according to the present embodiment.

In the image display system according to the present embodiment, the CPU 301 of the image processing apparatus 102 includes an enhanced image generation unit 4043 in addition to the configuration illustrated in FIG. 4 of the first embodiment. The components other than the enhanced image generation unit 4043 are similar to those in FIG. 4, so that same reference numerals are applied and descriptions are omitted.

The enhanced image generation unit 4043 generates enhanced images by executing image enhancement processing on the rendered images generated by the rendering unit 403. In the present embodiment, image processing for enhancing a specific color component (color channel) of each pixel value of a rendered image is executed as image enhancement processing.

In the present embodiment, descriptions are omitted with respect to the processing for setting a display mode and the processing for generating a display image by compositing a real image and a rendered image and displaying the display image on the HMD, because the processing is similar to the processing described in the first embodiment. Hereinafter, details of display image generation processing different from the first embodiment will be described.

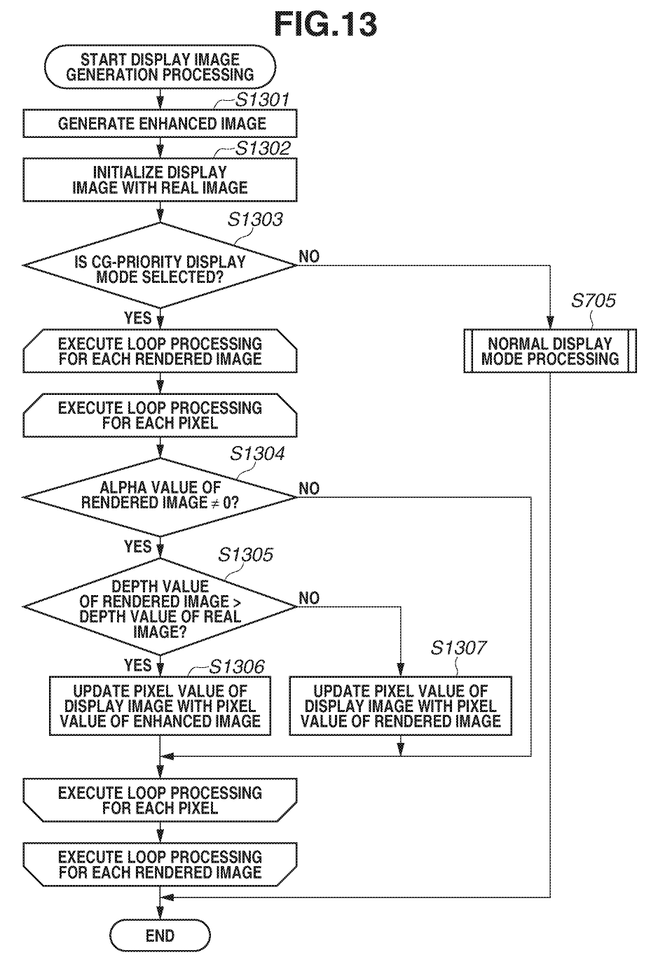

FIG. 13 is a flowchart illustrating details of display image generation processing according to the present embodiment.

In step S1301, the enhanced image generation unit 4043 generates enhanced images by executing image enhancement processing on the rendered images, and stores the enhanced images in the RAM 302. In the present embodiment, processing for enhancing a specific color channel is executed as the image enhancement processing. For example, in a case where the rendered image is an 8-bit image, only a value of a G channel is changed to 255 from among channels of R, G, and B.

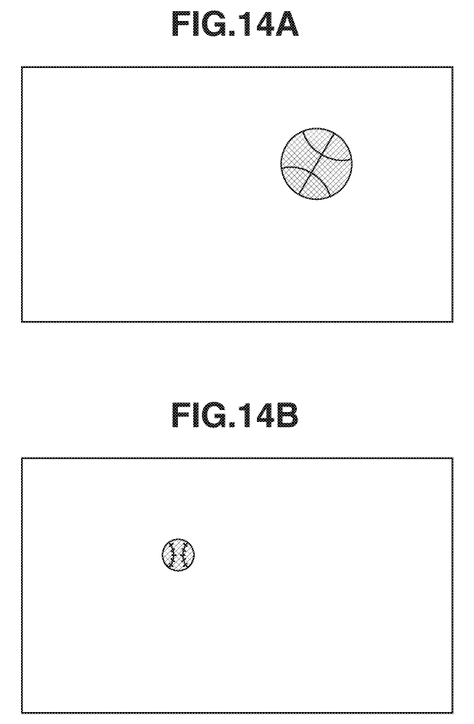

FIGS. 14A and 14B are diagrams schematically illustrating examples of the enhanced images generated from the rendered images in FIGS. 10B and 10C through the image enhancement processing. FIG. 14A illustrates the enhanced image of the rendered image in FIGS. 10B and 14B, illustrates the enhanced image of the rendered image in FIG. 10C.

In FIGS. 14A and 14B, enhanced images are generated so that colors of the CG objects expressed by hatched lines are enhanced in the green direction. Although the processing for enhancing a color is executed in the present embodiment, processing for generating an edge image may be executed as the image enhancement processing. Processing other than the above-described image enhancement processing may also be employed as long as a CG object clearly discriminable from a CG object displayed in a normal rendered image can be displayed.

In step S1302, the composition processing unit 4042 reads information about a real image from the RAM 302, and initializes pixel values of a display image with pixel values of the real image. At this point, the display image is equivalent to the real image.

In step S1303, the display mode determination unit 4041 acquires a display mode set in step S502 from the RAM 302, and determines whether the display mode is the CG-priority display mode.

In a case where the display mode is the CG-priority display mode (YES in step S1303), the processing proceeds to step S1304. On the other hand, in a case where the display mode is not the CG-priority display mode, i.e., the display mode is the normal display mode, (NO in step S1303), the processing proceeds to step S705.

In the subsequent steps, loop processing is performed for each rendered image. In the present embodiment, as described in step S602, for example, rendered images are generated from two different applications, respectively. Herein, because a plurality of rendered images, two, in this case, are present, processing is sequentially executed for the two rendered images. Further, the loop processing for each rendered image includes loop processing for each pixel. For each rendered image, the processing from S1304 to S1307 is repeatedly performed for each pixel.

In step S1304, the composition processing unit 4042 reads a rendered image, which is a processing target of the loop processing currently being executed, from the RAM 302, and determines whether the alpha channel value of the rendered image is 0. In a case where the alpha channel value is not 0, i.e., a CG object is present in the area, (YES in step S1304), the processing proceeds to step S1305. On the other hand, in a case where the alpha channel value is 0, i.e., a CG object is not present in the area, (NO in step S1304), the loop index of the pixel is updated, and the processing returns to step S1304.

In step S1305, the composition processing unit 4042 reads a depth image corresponding to the rendered image and a depth image corresponding to the real image from the RAM 302. Then, the composition processing unit 4042 compares the depth value of the depth image corresponding to the rendered image and the depth value of the depth image corresponding to the real image, and determines a magnitude relationship between the depth values. In a case where the depth value of the depth image corresponding to the rendered image is greater than the depth value of the depth image corresponding to the real image, i.e., a CG object is behind a real object, (YES in step S1305), the processing proceeds to step S1306. In a case where the depth value of the depth image corresponding to the rendered image is less than or equal to the depth value of the depth image corresponding to the real image, i.e., a CG object is in front of a real object, (NO in step S1305), the processing proceeds to step S1307.

In step S1306, the composition processing unit 4042 reads an enhanced image of the rendered image, which is a processing target of the loop processing currently being executed, from the RAM 302, and updates the pixel value of the display image with the pixel value of the enhanced image. Therefore, an enhanced CG object is displayed on this pixel.

In step S1307, the composition processing unit 4042 reads a rendered image, which is a processing target of the loop processing currently being executed, from the RAM 302, and updates the pixel value of the display image with the pixel value of the rendered image. Therefore, a normal CG object without enhancement is displayed on this pixel.

In step S705, the composition processing unit 4042 executes normal display mode processing. Descriptions are omitted because details of the processing are similar to the processing described in FIG. 8 of the first embodiment.

Through the above-described processing, when a display image is to be generated by compositing a real image and a rendered image, a display image in which a CG object is always displayed in the foreground is generated regardless of the front-to-back positional relationship (depth relationship) between a real object and the CG object. Further, according to the present embodiment, it is possible to generate a display image in which a CG object occluded by a real object and a CG object not occluded by a real object are displayed in a discriminable manner.

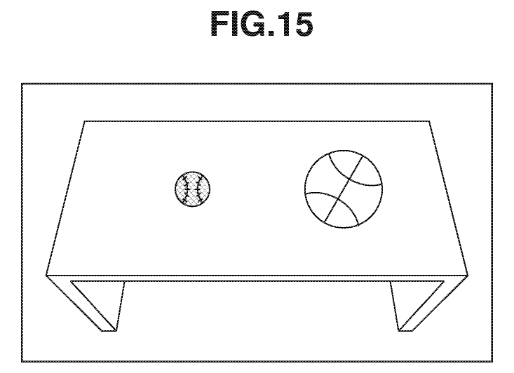

FIG. 15 is a diagram schematically illustrating an example of a display image generated by the CG-priority display mode processing according to the present embodiment.

As illustrated in FIG. 15, a display image in which two CG objects (i.e., a basketball and a baseball) are always displayed in the foreground of a real object (i.e., a desk) is generated without consideration for occlusion. The CG object (i.e., the baseball) is placed under the real object (i.e., the desk). Accordingly, originally, a proper way of illustrating the baseball is to make the baseball be occluded by the desk and not visible from the user's viewing point. However, in the CG-priority display mode, a display image in which a CG object is always displayed in the foreground is generated without consideration for the front-to-back relationship.

Further, in the present embodiment, the enhanced image illustrated in FIG. 14B is used for the baseball occluded by the desk (i.e., the real object). Therefore, the image is generated in a state where the baseball is visually discriminable from the basketball which is originally visible and not occluded by the desk (i.e., the real object). Accordingly, when the user searches for a CG object occluded by a real object, the user can easily find the occluded CG object and can easily recognize and discriminate the occluded CG object from the originally-visible CG object.

### Variation Example

Hereinafter, a variation example of the second embodiment will be described.

Because the right and left human eyes generally have parallax, there is a possibility of a situation where a CG object is occluded by a real object for one eye, and not occluded for the other eye. In this situation, in a case where a display image is generated by using an enhanced image for only one eye, the user may sense a flicker-like noise caused by occurrence of binocular rivalry when the user observes the image.

Further, generally, even in a case where the object is visible to only one of the eyes, a person can recognize the object as being visible. In other words, a person recognizes that the object is occluded and not visible only when the object is occluded in both of the right and left eyes.

Therefore, in this variation example, in step S1304 of FIG. 13 of the present embodiment, the composition processing unit 4042 executes processing for determining whether the CG object is occluded by the real object with respect to images for the right and the left eyes. Then, the enhanced image is used only when the CG object is determined to be occluded by the real object in both of the user's right and left eyes. In this way, it is possible to display an image that looks more natural to the human eyes, while suppressing occurrence of binocular rivalry.

In this case, it is necessary to perform processing on the same CG object for the right and the left eyes. In the present variation example, for example, an image with a label which discriminates a CG object is separately generated for each of the right and the left eyes when the CG object is rendered. Then, based on the label, the same CG object is specified as a target when the processing is executed for the right and the left eyes. For all pixels in an area assigned the same label, the composition processing unit 4042 determines whether the CG object is occluded by a real object in both of the eyes.

According to the present variation example, by executing the above-described processing, an image that looks more natural to the human eyes can be displayed, and the user can easily understand what kinds of CG objects are arranged in a space.

### Third Embodiment

A third embodiment will now be described. Similar to the first embodiment, the present embodiment is described with respect to a case where the present disclosure is applied to an image processing system including an HMD. The present embodiment is different from the first embodiment in that a CG object to be displayed is controlled based on a distance from the user in a case where the CG-priority display mode is selected.

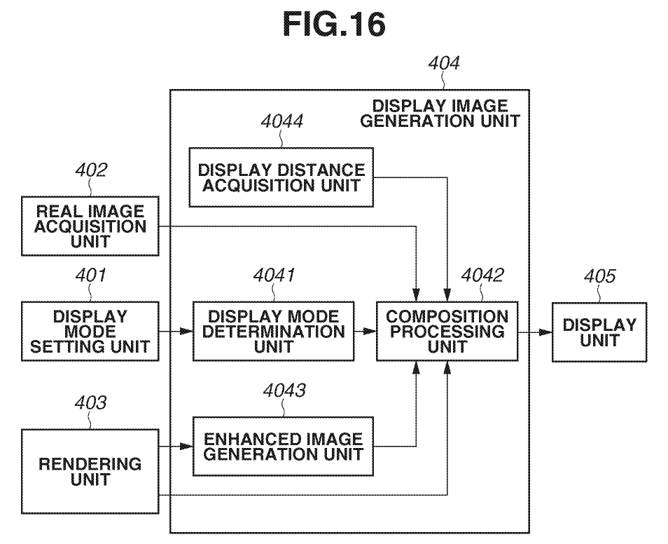

FIG. 16 is a block diagram illustrating an example of a configuration included in the CPU 301 of the image processing apparatus 102 according to the present embodiment.

In the image display system according to the present embodiment, the CPU 301 of the image processing apparatus 102 includes a display distance acquisition unit 4044 in addition to the configuration illustrated in FIG. 12 of the second embodiment. Components other than the display distance acquisition unit 4044 are similar to those in FIG. 12, so that same reference numerals are applied and descriptions are omitted.

The display distance acquisition unit 4044 is used when the composition processing unit 4042 generates a display image in which a CG object occluded by a real object is arranged in the foreground without consideration for occlusion, in a case where the display mode is the CG-priority display mode. The display distance acquisition unit 4044 acquires information for filtering this processing target CG object. Specifically, the display distance acquisition unit 4044 previously sets distance information used to determine up to what distance from the HMD user the CG objects are to be displayed, and executes processing for acquiring this preset value.

In the present embodiment, descriptions are omitted with respect to the processing for setting a display mode and processing for generating a composite image from a real image and a rendered image and displaying the composite image on the HMD because the processing is similar to the processing described in the first and the second embodiments. Herein, details of display image generation processing different from the first and the second embodiments are described.

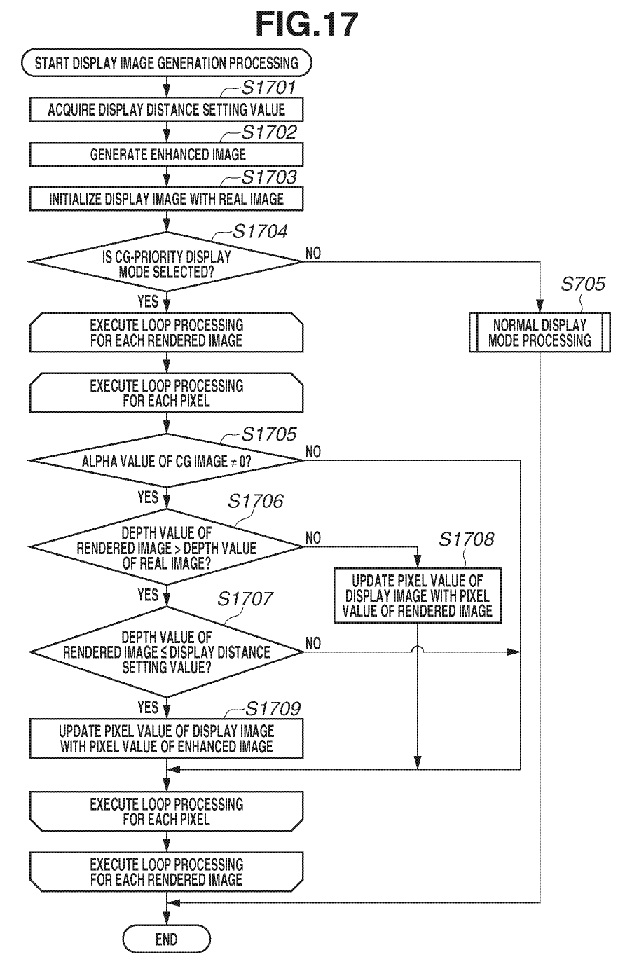

FIG. 17 is a flowchart illustrating details of display image generation processing according to the present embodiment.

In step S1701, the display distance acquisition unit 4044 acquires a preset display distance setting value from the RAM 302. This is distance information set so as to exclude a CG object located at a position farther than a predetermined distance threshold from a display target, that is, distance information that determines how far from the user of the HMD CG objects are to be displayed.

In step S1702, the enhanced image generation unit 4043 generates enhanced images by executing image enhancement processing on the rendered images, and stores the enhanced images in the RAM 302. The processing is similar to the processing in step S1301, so that descriptions are omitted.

In step S1703, the composition processing unit 4042 reads information about a real image from the RAM 302, and initializes pixel values of a display image with pixel values of the real image. At this point, the display image is equivalent to the real image.

In step S1704, the display mode determination unit 4041 acquires a display mode set in step S502 from the RAM 302, and determines whether the display mode is the CG-priority display mode. In a case where the display mode is the CG-priority display mode (YES in step S1704), the processing proceeds to step S1705. On the other hand, in a case where the display mode is not the CG-priority display mode, i.e., the display mode is the normal display mode, (NO in step S1704), the processing proceeds to step S705.

In the subsequent steps, loop processing is performed for each rendered image. In the present embodiment, as described in step S602, for example, the rendered images are generated from two different applications, respectively. Herein, because a plurality of rendered images, two, in this case, are present, processing is sequentially executed for the two rendered images. Further, the loop processing for each rendered image includes loop processing for each pixel. For each rendered image, the processing from S1705 to S1709 is repeatedly performed for each pixel.

In step S1705, the composition processing unit 4042 reads a rendered image from the RAM 302, and determines whether the alpha channel value of the rendered image is 0.

In a case where the alpha channel value is not 0, i.e., a CG object is present in the area, (YES in step S1705), the processing proceeds to step S1706. On the other hand, in a case where the alpha channel value is 0, i.e., a CG object is not present in the area, (NO in step S1705), the loop index of the pixel is updated, and the processing returns to step S1705.

In step S1706, the composition processing unit 4042 reads a depth image corresponding to the rendered image and a depth image corresponding to the real image from the RAM 302. Then, the composition processing unit 4042 compares the depth value of the depth image corresponding to the rendered image and the depth value of the depth image corresponding to the real image, and determines a magnitude relationship between the depth values. In a case where the depth value of the depth image corresponding to the rendered image is greater than the depth value of the depth image corresponding to the real image, i.e., a CG object is behind a real object, (YES in step S1706), the processing proceeds to step S1707. In a case where the depth value of the depth image corresponding to the rendered image is less than or equal to the depth value of the depth image corresponding to the real image, i.e., a CG object is in front of a real object, (NO in step S1706), the processing proceeds to step S1708.

In step S1707, the composition processing unit 4042 compares the depth value of the depth image corresponding to the rendered image with the display distance setting value acquired in step S1701. In a case where the depth value for the rendered image is less than or equal to the display distance setting value (YES in step S1707), the processing proceeds to step S1709. In a case where the depth value for the rendered image is greater than the display distance setting value (NO in step S1707), the loop index of the pixel is updated, and the processing returns to step S1705.

In step S1708, the composition processing unit 4042 reads a rendered image, which is a processing target of the loop processing currently being executed, from the RAM 302, and updates the pixel value of the display image with the pixel value of the rendered image. Therefore, a normal CG object without enhancement is displayed on this pixel.

In step S1709, the composition processing unit 4042 reads an enhanced image of the rendered image, which is a processing target of the loop processing currently being executed, from the RAM 302, and updates the pixel value of the display image with the pixel value of the enhanced image. Therefore, an enhanced CG object is displayed on this pixel.

In step S705, the composition processing unit 4042 executes normal display mode processing. Descriptions are omitted because details of the processing are similar to the processing described in FIG. 8 of the first embodiment.

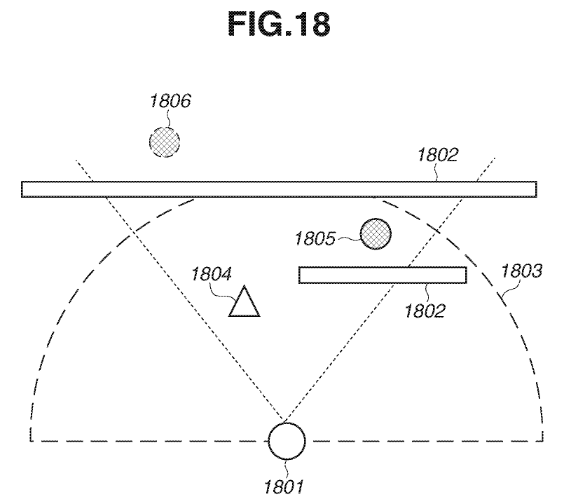

FIG. 18 is an overhead view illustrating a relationship between real objects, CG objects, and a display distance setting value according to the present embodiment.

A white circle 1801 indicates an HMD user and a viewing angle. Rectangles 1802 indicate walls as real objects, having the heights sufficient for blocking the user's view. A dashed line 1803 indicates a display distance setting value. CG objects falling within a range surrounded by the dashed line 1803 are displayed in a display image. A CG object 1804 is a CG object visible to the HMD user without being occluded by a real object. A CG object 1805 is a CG object occluded by a real object when viewed from the HMD user. A CG object 1806 is a CG object occluded by a real object when viewed from the HMD user and located at a position outside the display distance range.

By executing processing according to the flowchart in FIG. 17, the CG objects 1804 and 1805 are displayed in the generated display image, and the CG object 1805 is displayed in an enhanced manner. However, the CG object 1806 is not displayed because the CG object 1806 is located at a position outside the display distance range. As described above, according to the present embodiment, the CG object to be displayed in the display image can be controlled based on the optional display distance setting value.

Through the above processing, a search area can be limited when the user searches for a CG object occluded by a real object. For example, executing the above processing is effective and beneficial when only a user's vicinity is to be searched or when an area behind the wall does not have to be searched.

### Fourth Embodiment

A fourth embodiment will be described below. Similar to the first embodiment, the present embodiment will be described with respect to a case where the present disclosure is applied to an image processing system including an HMD. The present embodiment is different from the first embodiment in that rendered images generated by a plurality of different applications are switched and displayed according to an instruction from a user when the CG-priority mode is selected.

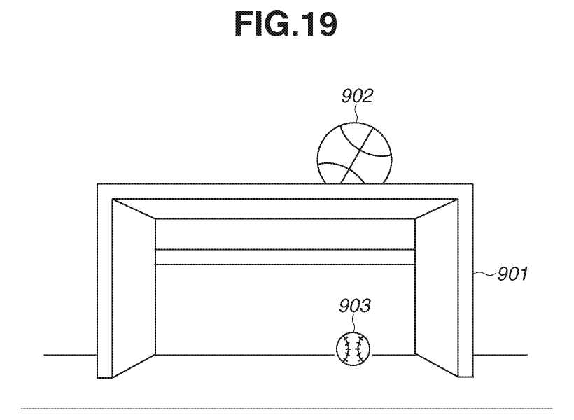

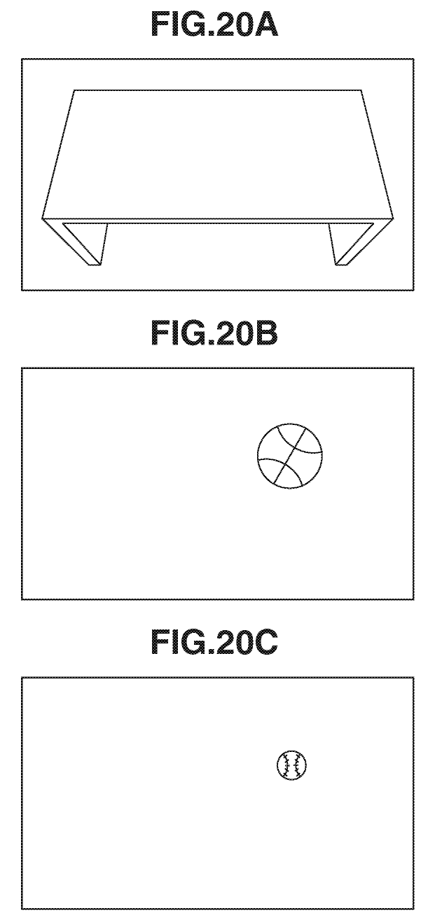

As illustrated in FIG. 19, it is assumed that a CG object 902 illustrating a basketball is placed on a desk 901 (i.e., a real object), and a CG object 903 representing a baseball is placed under the desk 901. In this case, when the user observes the objects through the HMD from a viewpoint illustrated in FIGS. 20A-20C, the CG object 902 of the basketball and the CG object 903 of the baseball are located at overlapping positions.

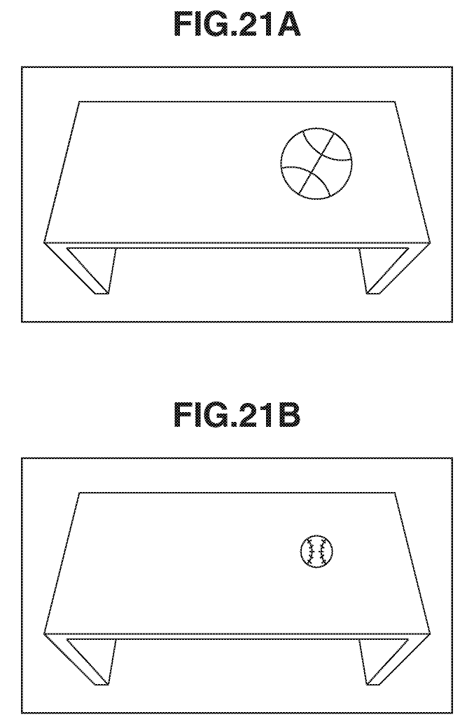

A case where the display image generation processing described with reference to FIG. 7 in the first embodiment is applied to the above-described situation will now be considered. In the CG-priority display mode, a rendered image of the baseball illustrated in FIG. 20C is firstly composited on a real image illustrated in FIG. 20A, and a rendered image of the basketball illustrated in FIG. 20B is further composited thereon. In this case, the baseball is completely overwritten with the basketball. As a result, as illustrated in FIG. 21A, only a CG object of the basketball is displayed as a display image, so that the user may not notice presence of a CG object of the baseball.

On the other hand, in the present embodiment, the user inputs an instruction for switching a composition-target rendered image through a controller (e.g., right and left arrow keys) (not illustrated), so that a rendered image to be composited with the real image is controlled based on the instruction. In the present embodiment, for example, two rendered images, a rendered image in FIG. 20B and a rendered image in FIG. 20C, are switched. The user issues an instruction for alternately switching the two rendered images by sequentially pressing right and left keys. By receiving this instruction, the image processing system can alternately display a plurality of CG objects, e.g., a display image in FIG. 21A in which a CG object of a basketball is composited and a display image in FIG. 21B in which a CG object of a baseball is composited. Through the processing, the user is allowed to notice presence of the basketball and the baseball.

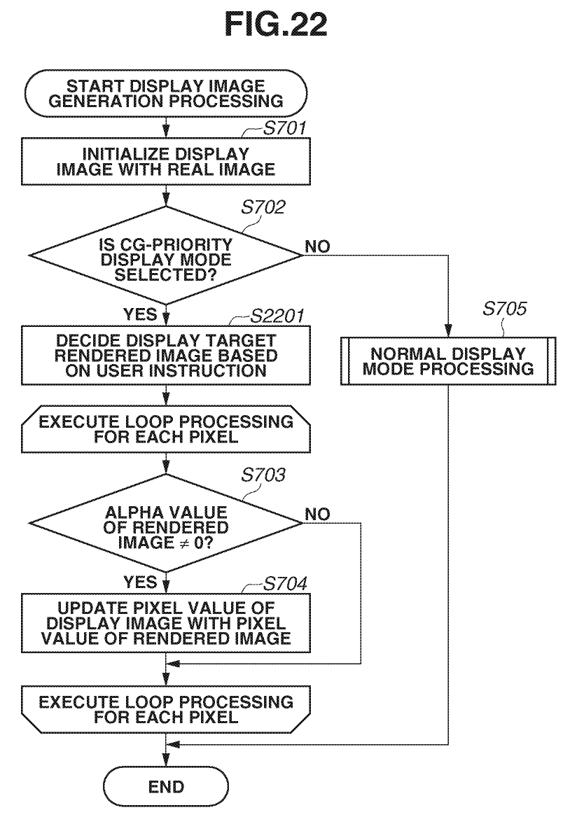

FIG. 22 is a flowchart illustrating details of display image generation processing according to the present embodiment.

The processing in steps S701 to S705 is similar to the processing described with reference to FIG. 7 in the first embodiment, so that descriptions are omitted.

In step S702, in a case where a display mode is the CG-priority display mode (YES in step S702), the processing proceeds to step S2201. In step S2201, the composition processing unit 4042 determines a rendered image as a display target based on the instruction from the user. For example, ID is previously set to each of the rendered images, so that the user switches a display target rendered image by changing the ID through an instruction input to a controller (e.g., right and left arrow keys) (not illustrated). Because the present embodiment illustrates a case where two rendered images are present, any of the two rendered images is set based on the user's instruction. In subsequent steps S703 and S704, processing is executed on the rendered image set in step S2201.

In the present embodiment, as described above, when there are a plurality of rendered images, it is possible to display desired CG objects in accordance with a user instruction (for example, sequentially displaying all CG objects when all of them are to be checked). Accordingly, the user can display and check each of CG objects even in a case where a plurality of CG objects overlap with each other. As described above, it is possible to provide the image processing apparatus 102 capable of allowing the user to easily understand what kinds of CG objects are arranged in a space.

In the present embodiment, the processing for switching a composition target rendered image based on a user's instruction has been described. However, a method for switching the rendered image is not limited to the above-described processing. For example, it is possible to automatically and sequentially switch a composition target rendered image at certain time intervals. In this way, even in a case where a plurality of CG objects overlap with each other, the user can display and confirm each of the CG objects without spending time and effort.

### Other Embodiments

In the above-described embodiments, a computer program for controlling the image processing apparatus 102 is stored in a storage medium such as the ROM 303. This computer program is a program for implementing respective functions of the CPU 301 of the image processing apparatus 102. The program implements respective functions of the display mode setting unit 401, the real image acquisition unit 402, the rendering unit 403, the display image generation unit 404 (i.e., the display mode determination unit 4041 and the composition processing unit 4042), and the display unit 405. The program further implements respective functions of the enhanced image generation unit 4043 and the display distance acquisition unit 4044. Specifically, the program implements the processing in respective steps, i.e., steps S501 and S502 in FIG. 5, steps S601 to S604 in FIG. 6, steps S701 to S705 in FIG. 7, steps S801 to S803 in FIG. 8, steps S1301 to S1307 in FIG. 13, steps S1701 to S1709 in FIG. 17, and step S2201 in FIG. 22. The CPU 301 serves as a computer to read the computer program from a storage medium such as the ROM 303 and to execute the computer program. Through the above-described processing, the CPU 301 controls the image processing apparatus 102.

Although the various embodiments of the present disclosure have been described, the present disclosure is not limited to these embodiments, and many variations and modifications are possible within the scope of the present disclosure.

According to the present disclosure, it is possible to provide an image processing apparatus capable of allowing a user to easily understand what kinds of virtual objects are arranged in a space, even in a case where a CG object is occluded by a real object.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-076760, filed May 2, 2025, which is hereby incorporated by reference herein in its entirety.

What is claimed is:

1. An image processing apparatus comprising:
a real image acquisition unit configured to acquire a real image;
a virtual image acquisition unit configured to acquire a virtual image; and
a composition processing unit configured to composite the real image and the virtual image through composition processing,
wherein, in a case where a predetermined display setting is set, the composition processing unit executes processing for displaying a virtual object regardless of a front-to-back positional relationship in occlusion between a real object in the real image and the virtual object in the virtual image.

2. The image processing apparatus according to claim 1, further comprising a display mode setting unit configured to set either of the predetermined display setting or a normal setting based on operation performed by a user.

3. The image processing apparatus according to claim 1, wherein the virtual image acquisition unit renders the acquired virtual image through rendering processing.

4. The image processing apparatus according to claim 1, further comprising a display unit configured to display a display image generated by the composition processing unit through composition processing.

5. The image processing apparatus according to claim 1, further comprising an enhanced image generation unit configured to generate an enhanced image by executing enhancement processing on the virtual image.

6. The image processing apparatus according to claim 5, wherein the composition processing unit compares depth information of the real image and the virtual image, composites the real image with the enhanced image in a case where the virtual image is determined to be farther than the real image, and composites the real image with the virtual image in a case where the virtual image is determined to be closer than the real image.

7. The image processing apparatus according to claim 5, wherein the enhanced image generation unit generates the enhanced image through processing for enhancing a specific color component of each pixel value of the virtual image.

8. The image processing apparatus according to claim 5, wherein the enhanced image generation unit generates an edge image of the virtual image as the enhanced image.

9. The image processing apparatus according to claim 5, wherein the composition processing unit composites the enhanced image with the real image, with respect to only the virtual object determined to be occluded by the real object in both of the right and left eyes of a user.

10. The image processing apparatus according to claim 1, further comprising a display distance acquisition unit configured to acquire distance information for controlling the virtual object to be displayed.

11. The image processing apparatus according to claim 10, wherein the distance information is information set so as to exclude the virtual object located at a position farther than a predetermined distance threshold from a display target.

12. The image processing apparatus according to claim 10, wherein, based on the distance information, the composition processing unit controls the virtual object to be displayed.

13. The image processing apparatus according to claim 1, wherein, in a case where the predetermined display setting is set, the composition processing unit switches and displays the virtual images according to an instruction from a user.

14. The image processing apparatus according to claim 1, wherein, in a case where the predetermined display setting is set, the composition processing unit sequentially switches and displays the virtual images at regular time intervals.

15. An image processing method comprising:
acquiring a real image;
acquiring a virtual image; and
compositing the real image and the virtual image through composition processing,
wherein, in a case where a predetermined display setting is set, processing for displaying a virtual object is executed regardless of a front-to-back positional relationship in occlusion between a real object in the real image and the virtual object in the virtual image.

16. A non-transitory computer-readable storage medium storing instructions for causing a computer to execute a image processing method, the method comprising:
acquiring a real image;
acquiring a virtual image; and
compositing the real image and the virtual image through composition processing,
wherein, in a case where a predetermined display setting is set, processing for displaying a virtual object is executed regardless of a front-to-back positional relationship in occlusion between a real object in the real image and the virtual object in the virtual image.
